(19) United States
(12) Patent Application Publication
(10) Pub. No.: US 2006/0251182 A1
(43) Pub. Date: Nov. 9, 2006

(54) Data communication system

(75) Inventor: Sel Brian Colak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,395

(22) PCT Filed: May 5, 2004
(86) PCT No.: PCT/IB04/50588

§ 371 Date: Nov. 2, 2005

(30) Foreign Application Priority Data
May 7, 2003 (EP) 03101260.2

(51) Int. Cl. H04B 7/02

(52) U.S. Cl. 375/267

(57) ABSTRACT

A communication system (1) comprises a plurality of at least three transmitters (11, 12, 13, 14). A data signal (S) is provided to all transmitters. Each transmitter transmits data signal fragments (31, 32, 33, 34). The data transmissions by the various transmitters are accurately synchronised, such that, on arrival in a target space (2), the various data signal fragments (31, 32, 33, 34) have an accurate timing relationship. Only a receiver (100) located at the target location will receive the various data signal fragments (31, 32, 33, 34) with the correct mutual timings.

The present invention relates to a communication system comprising at least one transmitter which transmits a data signal which can be received by a user receiver.

Communication systems of the above type are known in many types. The data link between transmitter and user can for instance be optical, radio, audio.

A specific problem arises if it is intended that the data transmission is confidential, because the signal emitted by the transmitter can in principle be picked up by receivers other than the intended receiver, which will hereinafter be indicated as target receiver. To solve this problem, several different approaches have been proposed.

One approach is that the data is coded. In such a system, it is accepted that non-target receivers receive the data, since it is assumed that the non-target receiver does not have the key to decode the message.

Another approach is that one tries to avoid non-target receivers receiving the data, for instance by emitting only a very narrow beam to the location where the target receiver is supposed to be located. Such system may, in principle, be implemented in optical transmissions, but nevertheless the beam may be intercepted. Further, if the data path from transmitter to target receiver is blocked by any obstruction, the target receiver does not receive the message.

The present invention aims to provide a different approach.

More particular, the present invention aims to provide a system where data signals can be received by other (i.e. non-target) receivers, but the data can nevertheless only be understood by the target receiver at the target location, without the necessity of coding the data.

According to an important aspect of the present invention, the system comprises a plurality of at least three transmitters. A data signal, originating from one common source, is provided to all transmitters. Each transmitter transmits at least a part of the data signal. The data transmission by the various transmitters is accurately synchronised, such that the various data signal parts are transmitted in an accurately timed relationship. Any receiver in the vicinity of the transmitters will receive all these various data signal parts, but the relative timing of these various data signal parts will depend on the exact location of such receiver. Only a receiver located at a predetermined target location will receive correctly timed data signal parts, and will be able to combine these data signal parts to reconstruct the original data signal.

These and other aspects, features and advantages of the present invention will be further explained by the following description of with reference to the drawings, in which same reference numerals indicate same or similar parts, and in which:

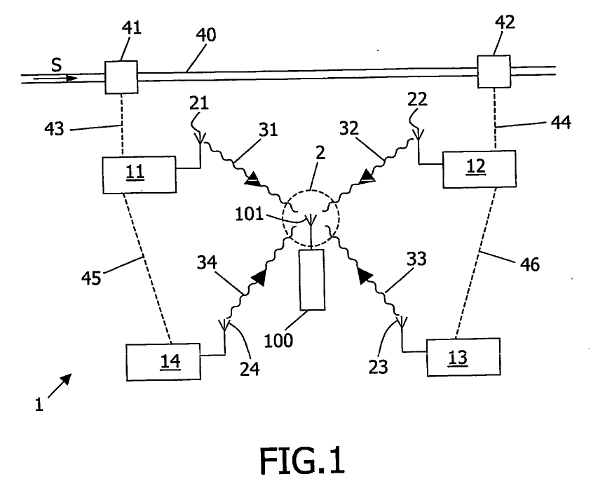

FIG. 1 schematically illustrates a setup of a data communication system according to the present invention;

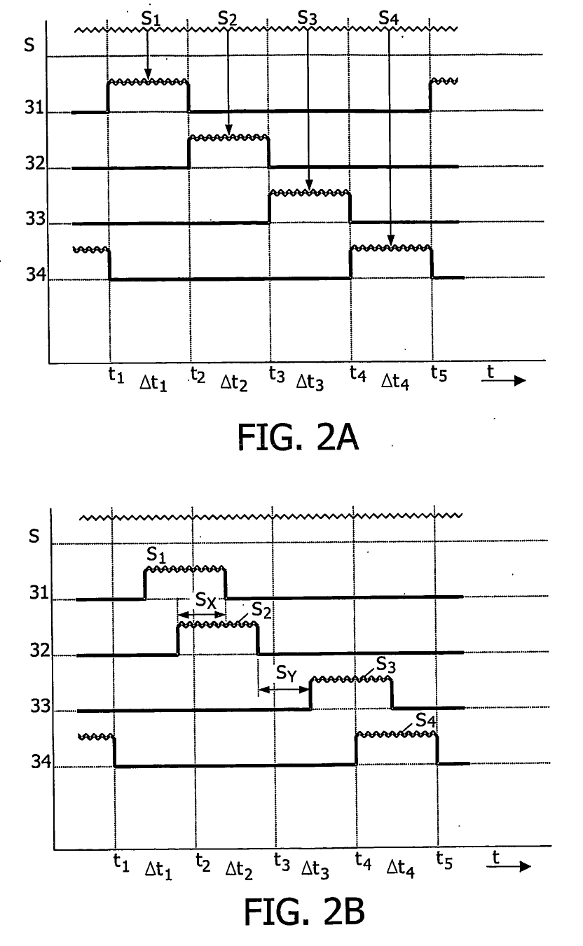

FIGS. 2A and 2B are timing diagrams, schematically illustrating the timing of data signals in a possible embodiment of the communication system according to the present invention;

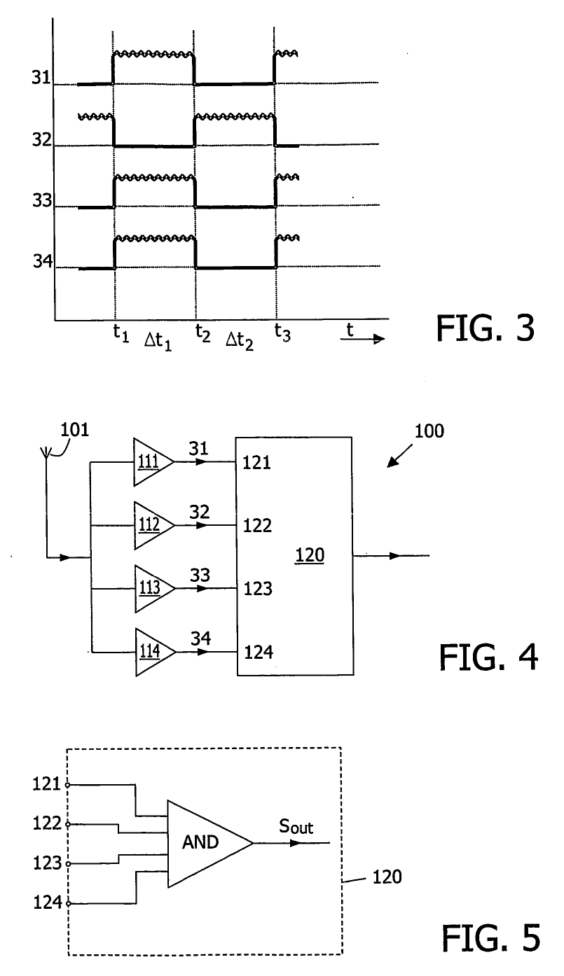

FIG. 3 is a timing diagram, schematically illustrating the timing of data signals in another possible embodiment of the communication system according to the present invention;

FIG. 4 is a block diagram, schematically illustrating a part of a receiver according to the present invention;

FIG. 5 is a block diagram, schematically illustrating details of an embodiment of a receiver according to the present invention;

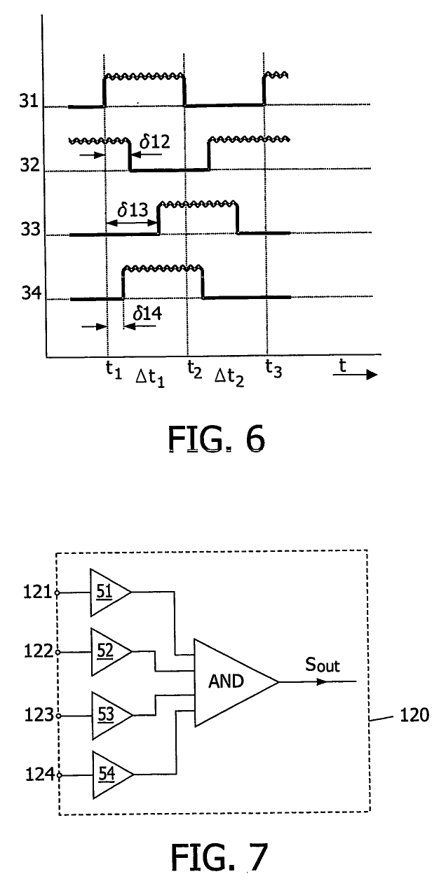

FIG. 6 is a timing diagram, schematically illustrating the timing of data signals in another possible embodiment of the communication system according to the present invention;

FIG. 7 is a block diagram, schematically illustrating details of an embodiment of a receiver according to the present invention.

FIG. 1 schematically shows a multi-path data communication system 1 comprising, in this embodiment, four transmitters 11, 12, 13, 14. The Figure also schematically shows a user receiver 100. Each transmitter 11, 12, 13, 14 is designed for transmitting a data signal 31, 32, 33, 34, respectively, that can be received by the user receiver 100. In the embodiment shown, each transmitter 11, 12, 13, 14 is an RF transmitter, provided with an RF antenna 21, 22, 23, 24, respectively, and the user receiver 100 is correspondingly provided with an RF receiving antenna 101.

A data signal, which is to be transmitted to the user receiver 100, is indicated as S, travelling over a source data channel 40. This source data channel 40 may be a wired channel or a wireless channel, for instance an optical channel. In an example, the source data channel 40 may be an Internet backbone.

All transmitters 11, 12, 13, 14 are coupled, directly or indirectly, to the source data channel 40. In the embodiment shown, the source data channel 40 comprises two data relay units 41, 42. The first data relay unit 41 receives the data signal S from any source, for instance a previous relay unit, not shown. The second data relay unit 42 receives the data signal S from the first data relay unit 41, and may pass the data signal S on to a next relay unit, not shown. The first data relay unit 41 also communicates to the first transmitter 11, as indicated by a data communication path 43. The second data relay unit 42 also communicates to the second transmitter 12, as indicated by a second data communication path 44. The first transmitter 11 also communicates to the fourth transmitter 14, as indicated by a third data communication path 45. The second transmitter 12 also communicates to the third transmitter 13, as indicated by a fourth data communication path 46.

It is noted that the first and second transmitters 11, 12 may both communicate to the same data relay unit.

It is further noted that all transmitters 11, 12, 13, 14 may communicate directly to respective data relay units, or even to one common data relay unit.

It is further noted that it is possible that only one transmitter communicates directly to a data relay unit, while all other transmitters communicate to this one transmitter, either directly or indirectly.

It is further noted that it is possible that one or more of the transmitters themselves are acting as data relay unit of the source data channel 40 or, vice versa, that one or more of the data relay units themselves are acting as transmitter.

The communication from a data relay unit to a transmitter may be wired or wireless; preferably, this communication takes place over an optical data communication path.

The communication between transmitters may be wired or wireless; preferably, this communication takes place over optical data communication paths.

FIG. 2A is a timing diagram, schematically illustrating the operation of the transmitters 11, 12, 13, 14 in an embodiment of the communication system 1, the horizontal axis in FIG. 2A representing time.

The upper curve in FIG. 2A represents the original data signal S. Four consecutive fragments of the original data signal S are indicated as data signal fragments S1, S2, S3, S4, respectively. The second curve in FIG. 2A shows that the first data signal fragment S1 is transmitted by the first transmitter 11 only. The third curve in FIG. 2A shows that the second data signal fragment S2 is transmitted by the second transmitter 12 only. The fourth curve in FIG. 2A shows that the third data signal fragment S3 is transmitted by the third transmitter 13 only. The fifth curve in FIG. 2A shows that the fourth data signal fragment S4 is transmitted by the fourth transmitter 14 only.

Thus, the four transmitters 11, 12, 13, 14 transmit different fragments of the data signal S in the order as mentioned. A next data signal fragment S5 may be transmitted by the first transmitter 11 again, and so on, so that the transmission order of the various transmitters always remains the same, but it is also possible that the transmission order of the various transmitters varies.

According to an important aspect of the present invention, the relative timings of the transmissions by the various transmitters 11, 12, 13, 14 is crucial. The first data signal fragment S1 is received by the receiver 100 during a first time interval Δt1 from a first time t1 to a second time t2. The second data signal fragment S2 is transmitted by the second transmitter 12 such that it is received by the receiver 100 during a second time interval Δt2 from the second time t2 to a third time t3, accurately following the first time interval Δt1, as illustrated in FIG. 2A, although a brief time gap between these two time intervals may be acceptable. In this respect, it is noted that the data transfer of data signal S, although shown as being continuous in the upper curve of FIG. 2A, is actually a pulsed transfer with gaps between the subsequent pulses, as will be known to a person skilled in the art.

Thus, the relative timing of the second transmitter 12 with respect to the first transmitter 11 is set such that, taking into account the distance between the receiver 100 and the first transmitter 11 and the distance between the receiver 100 and the second transmitter 12, the receiver 100 receives the start of the second data signal fragment S2 immediately following the end of the first data signal fragment S1.

Similarly, the third data signal fragment S3 is received by the receiver 100 during a third time interval Δt3 from the third time t3 to a fourth time t4, accurately following the second time interval Δt2, although a brief time gap between these two time intervals may be acceptable. Thus, the relative timing of the third transmitter 13 with respect to the second transmitter 12 is set such that, taking into account the distance between the receiver 100 and the third transmitter 13 and the distance between the receiver 100 and the second transmitter 12, the receiver 100 receives the start of the third data signal fragment S3 immediately following the end of the second data signal fragment S2.

Likewise, the fourth data signal fragment S4 is received by the receiver 100 during a fourth time interval Δt4 from the fourth time t4 to a fifth time t5, accurately following the third time interval Δt3, although a brief time gap between these two time intervals may be acceptable. Thus, the relative timing of the fourth transmitter 14 with respect to the third transmitter 13 is set such that, taking into account the distance between the receiver 100 and the third transmitter 13 and the distance between the receiver 100 and the fourth transmitter 14, the receiver 100 receives the start of the fourth data signal fragment S4 immediately following the end of the third data signal fragment S3.

Likewise, the relative timing of the first transmitter 11 with respect to the fourth transmitter 14 is set such that, taking into account the distance between the receiver 100 and the first transmitter 11 and the distance between the receiver 100 and the fourth transmitter 14, the receiver 100 receives the start of the fifth data signal fragment S5 immediately following the end of the fourth data signal fragment S4.

The above-described timing-relationship of the arrival of the various data signal fragments only applies in a relatively small target space 2, which may have dimensions in the order of 10 cm to 1 m. Only a receiver located within this target space 2 will receive the uncorrupted data signal S, as if the received signal originates from one continuously transmitting transmitter. An important advantage of this embodiment is that no adaptations of the receiver are necessary.

A receiver located outside the small target space 2 will only receive a corrupted data signal S, as illustrated in FIG. 2B, which is a graph comparable to FIG. 2A, showing data fragments received by a non-target receiver located closer to the second transmitter 12, and showing the “original” time intervals Δt1, Δt2, Δt3, Δt4 associated with the target space 2. The distance from the first transmitter 11 to the non-target receiver is larger than the distance from the first transmitter 11 to the target space 2, so the non-target receiver receives the first data signal fragment S1 later than the first time interval Δt1. The distance from the second transmitter 12 to the non-target receiver is smaller than the distance from the second transmitter 12 to the target space 2, so the non-target receiver receives the second data signal fragment S2 earlier than the second time interval Δt2. Thus, the first data signal fragment S1 and the second data signal fragment S2 have some overlap SX, which may lead to such distortions that these parts of the data fragments are lost for the receiver.

The distance from the third transmitter 13 to the non-target receiver is larger than the distance from the third transmitter 13 to the target space 2, so the non-target receiver receives the third data signal fragment S3 later than the third time interval Δt3. Thus, a relative large time gap SY is present between the second data signal fragment S2 and the third data signal fragment S3, which may also result in loss of data. Only a receiver located within the target space 2 will receive correctly timed data signal fragments, and will be able to combine these data signal parts to fully reconstruct the original data signal.

In the above, it has been mentioned that each transmitter 11, 12, 13, 14 communicates to the source data channel 40, either directly or indirectly. Thus, each transmitter 11, 12, 13, 14 may receive the original data signal S in full, and transmit only the required fragments during the required time intervals. However, it is also possible that each transmitter 11, 12, 13, 14 only receives those data signal fragments which it is required to transmit, thus reducing the data flow in the system 1.

In the above-described embodiment, the transmitters 11, 12, 13, 14 are operative such that their signals are received in different time intervals. In each time interval, the receiver 100 receives only one signal from one of the transmitters 11, 12, 13, 14. In further processing, and possibly decoding, each data fragment as received in a time interval is taken by itself. In another possible embodiment, the receiver 100 is adapted to receive two (or more) data fragments from two (or more) transmitters, which data fragments together are processed and possibly decoded only if they have a correct timing relationship with respect to each other, as will be explained in the following with reference to FIG. 3.

Like FIG. 2A, FIG. 3 is a graph illustrating four signals 31, 32, 33, 34 in their timing as received at the target space 2. It should be clear that the relative timing of transmission by the transmitters 11, 12, 13, 14 depends on the position of the target space 2 with respect to these transmitters 11, 12, 13, 14. For illustrating this embodiment of the invention, FIG. 3 shows only two time intervals Δt1 (from first time t1 to second time t2) and Δt2 (from second time t2 to third time t3).

A receiver 100 is adapted to receive four signals 31, 32, 33, 34 from four transmitters 11, 12, 13, 14 simultaneously, and to process these four signals 31, 32, 33, 34 simultaneously. In a possible embodiment, the four signals 31, 32, 33, 34 may be transmitted at mutually different transmission frequencies, the receiver 100 having four input filters 111, 112, 113, 114 tuned to these predetermined transmission frequencies, to derive the four signals 31, 32, 33, 34 from its antenna 101 input signal, as should be clear to a person skilled in the art Outputs of these four input filters 111, 112, 113, 114 are coupled to respective inputs 121, 122, 123, 124 of a processing unit 120, as illustrated in FIG. 4.

An aspect of the system 1 in this embodiment is a predetermined timing coding of the four signals 31, 32, 33, 34. For instance, as illustrated in FIG. 3, the processing unit 120 is programmed to expect to receive, during any time interval, correlated data at its first, third and fourth inputs 121, 123, 124, and to receive no data signal at its second input 122. If a combination of data signals 31, 32, 33, 34 meets this condition, as do the signals illustrated in FIG. 3 during the first time interval Δt1, the processing unit 120 is programmed to consider these signals as being valid, and win proceed with processing these signals. If a combination of data signals 31, 32, 33, 34 does not meet said condition, as do the signals illustrated in FIG. 3 during the second time interval Δt2, the processing unit 120 is programmed to consider these signals as being invalid, and will ignore these signals.

Thus, only a receiver located at the target space 2 will receive the data fragments of the data signals 31, 32, 33, 34 with the correct timing relation, and will be capable of correctly processing the meaningful data fragments. In a receiver located outside the target space 2, the relative timing of the data signals 31, 32, 33, 34 will be different. For instance, assume an infringing receiver located closer to the second transmitter 12. In that case, the second data signal 32 will arrive earlier, so that, during the first time interval Δt1, the processing unit 120 will receive a data signal at its second input 122. Since the processing unit 120 is programmed to consider all signals during the entire first time interval Δt1 as being invalid, the processing unit 120 will ignore these signals.

Thus, the presence or absence of a data signal during a predetermined time interval can be interpreted as a binary code of one bit, and the combination of all these bits relating to all data channels can be considered as constituting a binary code word. In this interpretation, the processing unit 120 is programmed to accept the data signals received at its inputs during a predetermined time interval only of the binary code word formed by the data signals during this predetermined time interval has a predetermined value. In the example of FIG. 3, this predetermined value would be 1011.

In the example as explained above, the contents of the second data signal 32 would always be lost. This can be avoided if the processing unit 120 would be programmed to also accept the complementary code word, in this case 0100. Then, independent from the predetermined value of the code word, the system 1 would always be capable of transmitting a total of four data signal fragments in two consecutive time intervals.

Alternatively, it is also possible that the processing unit 120 is programmed to accept all code words having thee 1s and one 0, i.e. 0111, 1011, 1101, 1110. In that case, the transmitters 11, 12, 13, 14 may rotate the four acceptable code words for consecutive time intervals, while the system 1 would always be capable of transmitting a total of six data signal fragments in two consecutive time intervals.

In the above example, it is assumed that the data contents of the data signal fragments are independent from each other. However, it is also possible that the data contents of the data signal fragments are related to each other in accordance with a predetermined coding. For instance, it may be possible that the data signal fragments are mutually identical. In that case, constructive interference will occur at the target space 2 if the data signal fragments are transmitted at the same frequency, whereas destructive interference will occur outside the target space 2. If the data signal fragments are transmitted at different frequencies, and received by the processing unit 120 at different inputs, as explained with reference to FIG. 4, the processing unit 120 may be designed to perform an AND operation on its four input signals, as illustrated in FIG. 5. The output signal Sout resulting from this AND operation will only be a meaningful signal if the receiver is located within the target space 2.

It should be clear that, alternatively, it is possible to use different predetermined logical combinations, according to Sout=f(S31, S32, S33, S34).

Thus, in accordance with the present invention, a secure data communication to a certain target space 2 is effected by transmitting separate data signal fragments such that, on arrival at the target space 2, they have a predetermined timing synchronisation relationship. In the above examples, this predetermined timing synchronisation relationship was based on simultaneous presence or absence, i.e. the separate data signal fragments were analysed within the same absolute time interval. However, this is not necessary. It is possible to use predetermined timing delays between the separate data signal fragments. An example of such embodiment is illustrated in FIG. 6, which is a graph comparable to FIG. 3. The first time interval Δt1, from time t1 to time t2, is indicated again. In this case, the first time interval Δt1 relates to first data signal 31. A corresponding time interval relating to second data signal 32 is shifted over δ12 with respect to the first time interval Δt1. A corresponding time interval relating to third data signal 33 is shifted over δ13 with respect to the first time interval Δt1. A corresponding time interval relating to fourth data signal 34 is shifted over δ14 with respect to the first time interval Δt1. The processing unit 120 is designed to expect these time shifts, and to take these expected time shifts into account when processing the data signals 31, 32, 33, 34. For instance, as illustrated in FIG. 7, the processing unit 120 may comprise four delay circuits 51, 52, 53, 54 coupled to its inputs 121, 122, 123, 124, respectively, set to effect delays τ, (τ-δ12), (τ-δ13), (τ-δ14), respectively.

It should be clear that the output signals of these four delay circuits 51, 52, 53, 54 have a timing relationship as illustrated in FIG. 3, so the further processing of the output signals of these four delay circuits 51, 52, 53, 54 may be identical as described above.

In the above example, τ is an arbitrary delay. If τ is chosen to be zero, the first delay circuit 51 may be omitted. It should be clear that the example of FIG. 3 is obtained if δ12=δ13=δ14=0.

It is possible that the target space 2 is fixed, and that the transmitters 11, 12, 13, 14 operate in a fixed timing relationship with respect to each other. However, in a preferred embodiment, the transmitters 11, 12, 13, 14 of the system 1 are designed to adapt their timing such that the target space 2 is located at a location corresponding to the location of a target receiver.

In such preferred embodiment, the transmitters 11, 12, 13, 14 of the system 1 need to have information on the relative timing which is to be effected. In one embodiment, this may be implemented in that the target receiver 100 is adapted to communicate its location to the system. For instance, the target receiver 100 may be equipped with a GPS receiver, which provides very accurate position signals to the target receiver 100. Since the GPS system for determining position is known per se, it is not necessary here to explain its operation in more detail. The transmitters 11, 12, 13, 14, typically being fixed transmitters at a fixed position, can have information regarding their position contained in a memory, or the transmitters 11, 12, 13, 14 of the system 1 may also each be equipped with GPS receivers.

In operation, a user will activate his receiver 100, which will send a request for secure communication service to the system 1. In this request, or during a later initialisation procedure, the receiver 100 will include data relating to its position. In response, the system 1 will set the timing of the transmitters 11, 12, 13, 14 such that the position of the target space 2 corresponds to the position of the receiver 100. During the duration of the communication, the receiver 100 will repeat communicating its position to the system, so that the setting of the timing of the transmitters 11, 12, 13, 14 may be continuously adapted, so that the user may actually be moving.

It is possible that the handling of the user request, and the setting of the timing of the transmitters 11, 12, 13, 14, is effected under the control of one central controller (not shown), common to all transmitters, and communicating to all transmitters, for instance over the backbone 40. It is also possible that one of the transmitters 11, 12, 13, 14 acts as central controller, so that a master/slave relationship exists between this one controller transmitter and the other transmitters. It is also possible that the set of transmitters 11, 12, 13, 14 together form an intelligent system, capable of adequately determining their settings, without necessarily one transmitter being hierarchically higher than others.

In another embodiment, in stead of sending position information, the transmitters 11, 12, 13, 14 and the user receiver 100 may be equipped with very accurate clock-signal generating means, and the receiver 100 may be adapted to send a signal containing time-of-sending information to the transmitters 11, 12, 13, 14. On receiving this signal, each transmitter compares the time-of-sending information with the time of reception as indicated by its own clock-signal generating means, and is thus capable of determining time of propagation of the signal from the receiver 100 to the transmitter. Thus, the system 1 is capable to calculate the distance from the receiver 100 to each of the transmitters 11, 12, 13, 14, and, by triangulation, is capable to calculate the position of the receiver 100. Even without calculating the actual position of the receiver 100, the system 1 is capable to determine the required relative timing of the signals 31, 32, 33, 34 by comparing the times of propagation.

It is possible that the timing relationship between the various data signals is constant, or, as mentioned above, varies according to a predetermined scheme. In a preferred embodiment, the user receiver 100 is capable of communicating to the transmitters a timing relationship request, i.e. a request defining parameters of the timing relationship. These parameters may include the timing delays between separate data signal fragments as explained with reference to FIG. 6, and/or the value of the multipath coding word as explained with reference to FIG. 3. In response, the system of transmitters will adapt their timing and/or multipath coding in accordance with the user request. The user receiver 100 is free to make such request at any time. The timing of such request may be at random; the same applies to the requested parameter values. An important advantage is achieved in that it becomes more difficult for intruding receivers to intercept and decode the signal transfer from transmitters to receiver, i.e. the security of the communication is improved.

Although not essential, it is preferred that the layout of the system 1 is such that the target space 2 for receivers 100 is located more or less within a geometrical Figure having its corners coinciding with the transmitters. In the case of three transmitters, such geometrical Figure is a triangle. In the case of four transmitters located in one plane, such geometrical Figure is a quadrangle. The mutual distance between the transmitters is not critical, but for reasons of accuracy it is preferred that this distance is not too large. If it is required to cover a relatively large area, the system needs to comprise more transmitters, arranged according to a mesh network, wherein different transmitters may take over the task from other transmitters as the user moves across the area covered by the system. Thus, the costs of the system increase as the mutual distance between the transmitters is decreased. A further aspect is that the transmitters need to have a power source. In a preferred embodiment of the present invention, the transmitters are associated with lamps of street lighting, for instance mounted in or on lamp housings or fixed to lamp posts. In such embodiment, the power provision is not a problem since power provision is already present in such lamps. Further, the mutual distance between lamp posts of street lamps, typically in the order of about 30 m, is suitable for use in the system of the present invention.

It should be clear to a person skilled in the art that the present invention is not limited to the exemplary embodiments discussed above, but that several variations and modifications are possible within the protective scope of the invention as defined in the appending claims.

For instance, in the above, the communication system has four transmitters, but it should be clear that the number of transmitters could be five or more, or could be equal to three. In some circumstances, the number of transmitters could be equal to two. In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Multi-path communication system (1), comprising:
a plurality of at least two, preferably at least three transmitters (11, 12, 13, 14); feeding means (40) for feeding a data signal (S) to the system (1);
distributing means (41, 42, 43, 44, 45, 46) for distributing data signal fragments (S1, S2, S3, S4) to the transmitters (11, 12, 13, 14);
determination means for determining a position of a target space (2); wherein the transmitters (11, 12, 13, 14) of the system (1) are designed to transmit data signals (31, 32, 33, 34) in an accurate synchronisation, such that, in the said target space (2), the data signals (31, 32, 33, 34) arrive with a predetermined mutual timing relationship.

2. Communication system according to claim 1, wherein mutual distances between the transmitters (I 1, 12, 13, 14) are in the order of 10-100 m, preferably in the order of about 30 m.

3. Communication system according to claim 2, wherein the transmitters (I 1, 12, 13, 14) are associated with lighting armatures or lighting posts, preferably street lighting.

4. Communication system according to claim 1, wherein the transmitters (I 1, 12, 13, 14) are capable of communicating to each other, either directly or indirectly, preferably over an optical communication path.

5. Communication system according to claim 1, wherein the target space (2) has a predetermined, fixed position.

6. Communication system according to claim 1, wherein the determination means are designed to determine the target space (2) as being located at the position of a target receiver (100).

7. Communication system according to claim 6, wherein a target receiver (100) is designed to communicate its position to the system (1).

8. Communication system according to claim 7, wherein the target receiver (100) comprises a GPS-receiver or other means for determining its own position.

9. Communication system according to claim 1, designed to calculate the distance from each of the transmitters (11, 12, 13, 14) to the position of the target space (2).

10. Communication system according to claim 1, designed to calculate the signal propagation time from each of the transmitters (11, 12, 13, 14) to the position of the target space (2).

11. Communication system according to claim 1, wherein each of the transmitters (11, 12, 13, 14) comprises a GPS-receiver or other means for determining its own position.

12. Communication system according to claim 1, wherein the data signal (S) is divided into consecutive data signal fragments (S1, S2, S3, S4), wherein the data signal fragments (S1, S2, S3, S4) are transferred to corresponding transmitters (11, 12, 13, 14), and wherein the transmitters (11, 12, 13, 14) are designed to transmit the respective data signal fragments (S1, S2, S3, S4) at such timing that the data signal fragments (S1, S2, S3, S4) arrive at the said target space (2) in the same timing relationship as in the original data signal (S).

13. Communication system according to claim 1, wherein the transmitters (11, 12, 13, 14) are designed to transmit their data signal fragments (S1, S2, S3, S4) at such timing that the data signal fragments (S1, S2, S3, S4) arrive at the said target space (2) with predetermined mutual timing differences (δ12, δ13, δ14).

14. Communication system according to claim 13, wherein said timing differences (δ12, δ13, δ14) are equal to zero.

15. Communication system according to claim 13, further comprising a receiver (100) with receiving means (101, 111, 112, 113, 114) for separately receiving the data signal fragments (S1, S2, S3, S4) from the different transmitters (11, 12, 13, 14), the receiver (100) further comprising a processing unit (120) for processing the data signal fragments (S1, S2, S3, S4), wherein the processing unit (120) is designed to take said timing differences (δ12, δ13, δ14) into account.

16. Communication system according to claim 15, wherein the processing unit (120) comprises a plurality of inputs (121, 122, 123, 124) for receiving the data signal fragments (S1, S2, S3, S4) from said receiving means (101, 111, 112,113, 114), the processing unit (120) further comprising at least one delay unit associated with at least one input (121, 122, 123, 124).

17. Communication system according to claim 15, wherein the processing unit (120) is designed to calculate an output data signal (Sout) according to a predetermined function f.

18. Communication system according to claim 15, wherein the presence or absence of a data signal is interpreted as a binary code bit, wherein the time-correlated presence or absence of all data signals (31, 32, 33, 34) is interpreted as a binary code word, and wherein the processing unit (120) is designed to accept the data signals (31, 32, 33, 34) only if said binary code word has a predetermined value (1011).

19. Communication system according to claim 1, wherein the transmitters ( 1, 12, 13, 14) are designed, in response to receiving a timing relationship request from a target receiver (100), to adapt said predetermined mutual timing relationship in accordance with the said request.

20. Receiver (100) for a communication system according to claim 1, designed to communicate its position to the system (1).

21. Receiver according to claim 20, comprising a GPS-receiver or other means for determining its own position.

22. Receiver (100) for a communication system according to claim 13, comprising receiving means (101, 111, 112, 113, 114) for separately receiving data signal fragments (S1, S2, S3, S4) from different transmitters (11, 12, 13, 14), the receiver (100) further comprising a processing unit (120) for processing the data signal fragments (S1, S2, S3, S4), wherein the processing unit (120) is designed to take into account predetermined mutual timing differences (δ12, δ13, δ14).

23. Receiver according to claim 22, wherein the presence or absence of a data signal is interpreted as a binary code bit, wherein the time-correlated presence or absence of all data signals (31, 32, 33, 34) is interpreted as a binary code word, and wherein the processing unit (120) is designed to accept the data signals (31, 32, 33, 34) only if said binary code word has a predetermined value (1011).

24. Receiver (100) for a communication system according to claim 19, designed to communicate to the system (1) a timing relationship request.
